(19) United States
(12) Patent Application Publication
(10) Pub. No.: US 2025/0348677 A1
(43) Pub. Date: Nov. 13, 2025

(54) METHOD AND SYSTEM FOR EXPANDING CONTEXT WINDOW

(71) Applicant: SAMSUNG SDS CO., LTD., Seoul (KR)

(72) Inventors: Sung Min LEE, Seoul (KR); Seungki Hong, Seoul (KR)

(73) Assignee: SAMSUNG SDS CO., LTD., Seoul (KR)

(21) Appl. No.: 19/201,408

(22) Filed: May 7, 2025

(30) Foreign Application Priority Data
May 8, 2024 (KR) 10-2024-0060493
Sep. 2, 2024 (KR) 10-2024-0118291

(51) Int. Cl. G06F 40/284; G06F 40/289

(52) U.S. Cl. CPC G06F 40/284; G06F 40/289

(57) ABSTRACT

Provided is a method performed by at least one computing device. The method may comprise extracting a summarization token sequence including a plurality of tokens from input data, the plurality of tokens including position information, a length of the summarization token sequence being within a reference length; and additionally training a pre-trained language model using the summarization token sequence, wherein the reference length corresponds to an initial context length of the pre-trained language model.

### CROSS-REFERENCE TO RELATED APPLICATIONS

This application claims priority from Korean Patent Application No. 10-2024-0060493 filed on May 8, 2024, and Korean Patent Application No. 10-2024-0118291 filed on Sep. 2, 2024, in the Korean Intellectual Property Office and all the benefits accruing therefrom under 35 U.S.C. 119, the contents of which in its entirety are herein incorporated by reference.

### BACKGROUND

### Technical Field

The present disclosure relates to a method and system for expanding a context window, and more particularly, to a method for cost-efficiently expanding a context window size of a language model, and a system thereof.

### Description of the Related Art

Recently, interest in a large language model (hereinafter, referred to as ‘LL M’) has been greatly increasing in various fields. One of important factors affecting usability of such LLM is a context window size. The context window size refers to the maximum number of input tokens that the LLM can process at one time. The larger the context window size is, the more examples (few-shots) and prior information can be included in a prompt and provided as inputs of the LLM, and thus, the LLM can generate and provide better answers. Accordingly, efforts for expanding the context window size of the LM M are actively being made.

As a method for expanding a context window size, position interpolation, Randomized Positional encodings (RandPos), and Positional Skip-wisE (PoSE) are known, but each of these methods has its own limitation. In detail, the position interpolation method is a method for adjusting position information to the context window size, and has a problem of increasing computational complexity. The RandPos method is a method for randomly selecting position information of tokens included in an input sequence, and has a problem of poor continuity between adjacent tokens. In addition, the PoSE method is a method for segmenting the input sequence into chunks and skipping some of them, and although continuity may be maintained between tokens, there is a limitation that important information of the input sequence may be lost due to random skipping.

Therefore, there is a need a research for a method capable of cost-efficiently expanding a context window size of a language model while complementing the limitations of the conventional methods for expanding a context window size.

### SUMMARY

An object of the present disclosure is to provide a method for cost-efficiently expanding a context window size of a language model, and a system thereof.

Another object of the present disclosure is to provide a method for generating training data including meaningful information and expanding a context window size of a language model using the training data, and a system thereof.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a method for expanding a context window, performed by at least one computing device. The method may comprise extracting a summarization token sequence including a plurality of tokens from input data, the plurality of tokens including position information, a length of the summarization token sequence being within a reference length; and additionally training a pre-trained language model using the summarization token sequence, wherein the reference length corresponds to an initial context length of the pre-trained language model.

In some embodiments, a length of the input data may correspond to a target context length of the pre-trained language model.

In some embodiments, the method may further comprise adding position information to the tokens constituting the input data prior to extracting the summarization token sequence.

In some embodiments, the position information may indicate an absolute position of the tokens constituting the input data.

In some embodiments, the extracting of the summarization token sequence may include generating a plurality of chunks by segmenting the input data, extracting a main token from each of the plurality of chunks using a summarization model, and generating the summarization token sequence using the extracted main tokens.

In some embodiments, each length of the plurality of chunks may be within a maximum token length of the summarization model.

In some embodiments, the extracting of a main token may include determining an extraction ratio of the main tokens based on a length of the input data and the initial context length of the pre-trained language model.

In some embodiments, the summarization model may be an extractive summarization model, which is pre-trained.

According to another aspect of the present disclosure, there is provided a system for expanding a context window. The system may include one or more processors and a memory configured to store one or more computer programs executed by the one or more processors, wherein the one or more computer programs include instructions for: an operation of extracting a summarization token sequence including a plurality of tokens from input data, the plurality of tokens including position information, a length of the summarization token sequence being within a reference length; and an operation of additionally training a pre-trained language model using the summarization token sequence, wherein the reference length corresponds to an initial context length of the pre-trained language model.

In some embodiments, a length of the input data may correspond to a target context length of the pre-trained language model.

In some embodiments, the system may further comprise instructions for an operation of adding position information to the tokens constituting the input data prior to the operation of extracting the summarization token sequence.

In some embodiments, the position information may indicate an absolute position of the tokens constituting the input data.

In some embodiments, the operation of extracting the summarization token sequence may include: an operation of generating a plurality of chunks by segmenting the input data; an operation of extracting a main token from each of the plurality of chunks using a summarization model; and an operation of generating the summarization token sequence using the extracted main tokens.

In some embodiments, each length of the plurality of chunks may be within a maximum token length of the summarization model.

In some embodiments, the operation of extracting a main token may include an operation of determining an extraction ratio of the main tokens based on a length of the input data and the initial context length of the pre-trained language model.

In some embodiments, the summarization model may be an extractive summarization model, which is pre-trained.

According to another aspect of the present disclosure, there is provided a non-transitory computer-readable storage medium storing computer program executable by a processor of a computer. The computer program may include instructions for: extracting a summarization token sequence including a plurality of tokens from input data, the plurality of tokens including position information, a length of the summarization token sequence being within a reference length; and additionally training a pre-trained language model using the summarization token sequence, wherein the reference length corresponds to an initial context length of the pre-trained language model.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary view illustrating an operation of a context window expansion system according to one embodiment of the present disclosure at a system level;

FIG. 2 schematically illustrates a detailed configuration of a context window expansion system according to one embodiment of the present disclosure;

FIG. 3 is a view schematically illustrating an operation performed in a training data generator of FIG. 2;

FIG. 4 is a view illustrating an operation of generating a plurality of chunks described in FIG. 3;

FIG. 5 illustrates a modified example of the embodiment described in FIG. 4;

FIG. 6 is a view illustrating an operation of extracting a main token described in FIG. 3;

FIG. 7 exemplarily illustrates position information of input data and training data;

FIG. 8 is an exemplary flow chart illustrating a method for expanding a context window according to another embodiment of the present disclosure;

FIG. 9 is an exemplary flow chart illustrating a detailed process of an extraction step; and

FIG. 10 is a block diagram illustrating a hardware configuration of a computing device according to some embodiments of the present disclosure.

### DETAILED DESCRIPTION OF THE DISCLOSURE

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

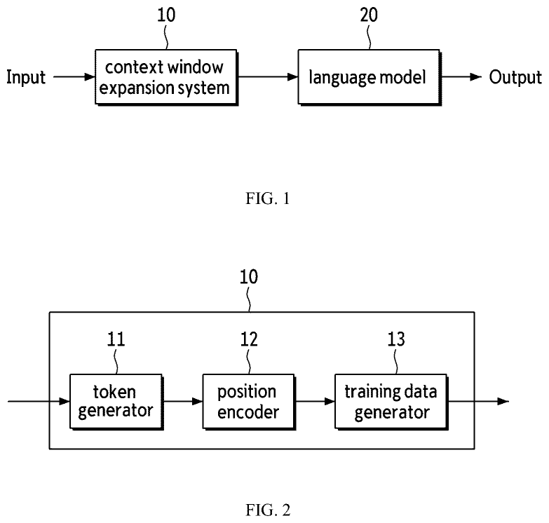

FIG. 1 is an exemplary view illustrating an operation of a context window expansion system according to one embodiment of the present disclosure at a system level.

As shown in FIG. 1, a context window expansion system 10 is a computing device/system having a function of expanding a context window size of a language model 20. The context window size refers to either a maximum input size that the language model 20 may process at a time or the amount of text that the language model 20 may consider when generating a response. In some cases, the context window size may be referred to as ‘context window length’, ‘context length’, ‘context size’, ‘maximum token length’, and ‘maximum number of tokens’. In addition, in the present specification, ‘length’ may mean ‘number of tokens’ or ‘context length’ constituting specific data (ex., input data, summarization token sequence, chunk, etc.).

The language model 20 is a model that is a target of expansion in the context window size, and may be any pre-trained language model. The language model 20 may be, for example, a transformer-based large-scale language model (LLM). The transformer-based large-scale language model trains correlation between input tokens through a self-attention mechanism, and in this process, position information of each token plays a very important role. However, when a token of a length exceeding a limited context length is input and thus new token position information that has not been previously trained is provided, its performance may be deteriorated or the model may not operate stably.

Accordingly, the present disclosure provides a method for expanding a limited context length (i.e., initial context length) of the language model 20 by additionally training token position information that has not been previously trained for the language model 20 through the context window expansion system 10.

Hereinafter, the configuration and function of the context window expansion system 10 will be described in detail.

FIG. 2 schematically illustrates a detailed configuration of a context window expansion system according to one embodiment of the present disclosure.

As shown in FIG. 2, the context window expansion system 10 according to one embodiment of the present disclosure may include a token generator 11, a position encoder 12, and a training data generator 13. However, the components shown in FIG. 2 do not reflect all the functions of the context window expansion system 10 and are not essential, and thus the context window expansion system 10 may include more or less components than the shown components.

The components shown in FIG. 2 represent functionally distinct functional elements, and may be implemented in a form in which a plurality of components are integrated with each other in an actual physical environment. In addition, each of the components may be implemented in a form separated into a plurality of detailed functional elements in an actual physical environment. For example, a first function of the training data generator 13 may be implemented in a first computing device, and a second function may be implemented in a second computing device.

In one embodiment of the present disclosure, the token generator 11 may perform tokenization for input data. Tokenization is a process in which the language model 20 segments input data in units that may be analyzed, and the token generator 11 may perform tokenization for input data in accordance with a tokenization method supported by the language model 20. For example, the token generator 11 may generate a plurality of tokens by separating components constituting the input data in units of spaces. As another example, the token generator 11 may generate a plurality of tokens by separating the components constituting the input data in units of morphemes. The input data may be text written in natural language, and its length may be longer than the initial context length of the language model 20 and may correspond to a target context length targeted by the language model 20. For example, when a language model having a context length limit of 4K is to be expanded to a context length of 16K, the length of the input data may be 16K.

In one embodiment of the present disclosure, the position encoder 12 may add position information to each token constituting the input data generated by the token generator 11. The position information plays an important role in understanding the order of each token within the input data and grasping the context, and may indicate an absolute position of the token constituting the input data.

In one embodiment of the present disclosure, the training data generator 13 may generate a training data set for expanding the context window size of the pre-trained language model.

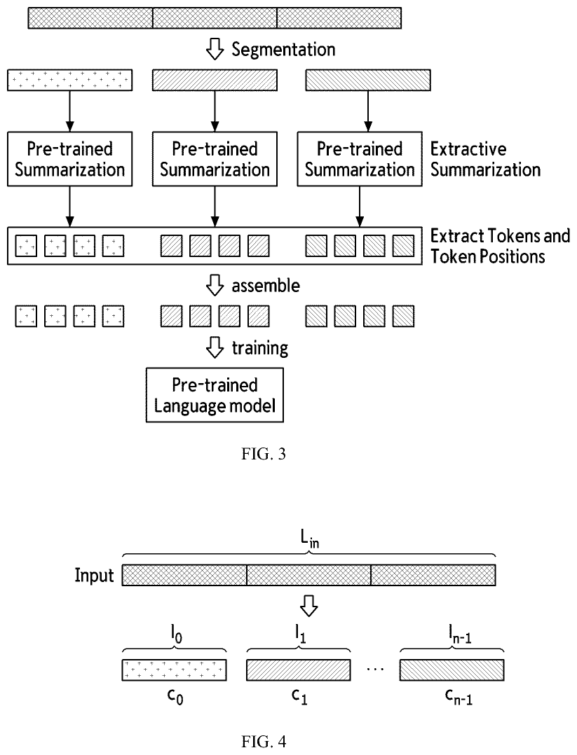

FIG. 3 is a view schematically illustrating an operation performed in the training data generator of FIG. 2.

As shown in FIG. 3, the training data generator 13 may generate a plurality of chunks by segmenting the input data, and may extract a main token from each of the plurality of chunks by using a pre-trained summarization model. In addition, the training data generator 13 may generate a summarization token sequence by using the extracted main token, and the generated summarization token sequence may be used as training data for expanding the context window of the pre-trained language model 20.

Hereinafter, the operation of the training data generator 13 will be described in more detail with reference to the drawings.

First, the operation of generating a plurality of chunks by segmenting input data will be described in detail.

FIG. 4 is a view illustrating an operation of generating a plurality of chunks described in FIG. 3.

As shown in FIG. 4, the training data generator 13 may generate a plurality of chunks c₀, c₁, . . . , c_{N-1} by segmenting input data Input. The chunk is obtained by dividing the input data into small units, and the input data may be adjusted to a size that the summarization model may process, through the segmentation operation.

In one embodiment, the number of the plurality of chunks may be determined based on the initial context length of the pre-trained language model and the maximum token length of the summarization model. Also, each length l₀, l₁, . . . , l_{N-1} of the plurality of chunks may be within the maximum token length of the summarization model. For example, when the maximum token length of the summarization model is 1024 and the length of the input data, that is, the length of the token constituting the input data is 100000, a plurality of chunks in which a length of each chunk is within the maximum token length of the summarization model may be generated by segmenting the input data into ten equal parts.

The plurality of generated chunks cᵢ may be expressed by the following Equation 1.

$${c}_{i} = [ {T}_{{u}_{i}} , {T}_{{u}_{i + 1}} , … , {T}_{{u}_{i} + {l}_{i} - 1} ] , \qquad [ Equation 1 ]$$

$$\{ \begin{matrix}{u}_{i} = 0 , & i = 0 \\ {u}_{i} = {\sum }_{0}^{i - 1} {l}_{j} , & otherwise\end{matrix}$$

In this Equation, Tᵤ is the (u)th token of the input data, and lᵢ represents a length of the chunk cᵢ.

In the example described in FIG. 4, the tokens constituting the plurality of chunks do not overlap each other, but in some cases, some of the tokens constituting the plurality of chunks may overlap each other.

FIG. 5 illustrates a modified example of the embodiment described in FIG. 4.

As shown in FIG. 5, a portion of the tokens constituting c₀ and a portion of the tokens constituting c₁ may overlap each other. In detail, a portion of the token positioned at the end of c₀ and a portion of the token positioned at the beginning of c₁ may overlap each other. In this case, important information may be prevented from being segmented and lost at a chunk boundary. As in the previous example, in the present example, the respective lengths l₀, l₁, . . . , l_{N-1} of the plurality of chunks are certainly within the maximum token length of the summarization model.

Next, the operation of extracting the main token from each of the plurality of chunks using the summarization model and generating the summarization token sequence using the extracted main token will be described in detail.

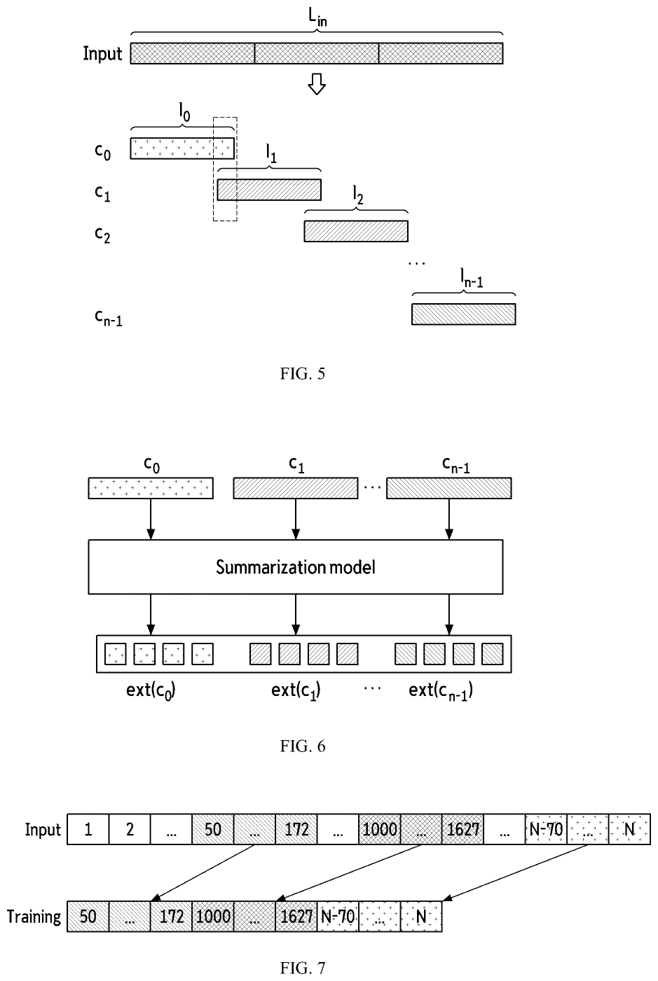

FIG. 6 is a view illustrating an operation of extracting a main token described in FIG. 3.

As shown in FIG. 6, the plurality of chunks may be sequentially input to one summarization model, and the main token may be extracted from each of the plurality of chunks through the summarization model. The summarization model may be an ‘extractive summarization model’ in which a token (i.e., a main token) that collectively represents important or related information is extracted from each of the plurality of input chunks to generate a summarization for each of the plurality of chunks. Therefore, the main tokens extracted through the summarization model may be tokens included in the input data, and may include position information in the input data. That is, through the summarization model, the main token of each of the plurality of chunks and position information corresponding to each of the main tokens may be obtained.

A main token of each chunk, which is extracted by a summarization model function ext(X), may be expressed as the following Equation 2.

$$ext ( {c}_{i} ) = [ {T}_{{u}_{i} + {ν}_{i , 0}} , {T}_{{u}_{i} + {ν}_{i , 1}} , … , {T}_{{u}_{i} + {ν}_{i , n}} ] , \qquad [ Equation 2 ]$$

In this Equation, v_{i,j} is a partial sequence of {0, 1, . . . , lᵢ−1}, and n denotes the length of the extracted main token.

In one embodiment, an extraction ratio of the main token through the summarization model may be determined using the length of the input data and the initial context length of the pre-trained language model. For example, when the initial context length of the pre-trained language model is Lₘₐₓ and the length of the input data is Lᵢₙ, the main token may be extracted at a ratio of Lₘₐₓ/Lᵢₙ.

The summarization token sequence dₜᵣₐᵢₙ generated by sequentially combining the main tokens extracted as described above may be expressed as the following Equation 3.

$${d}_{train} = e x t ( {c}_{0} ) \vert ext ( {c}_{0} ) \vert … \vert ext ( {c}_{N} ) ] . \qquad [ Equation 3 ]$$

As described above, the main token is extracted from each of the plurality of chunks in accordance with the extraction rate determined using the initial context length of the language model the length of the input data, and the summarization token sequence dₜᵣₐᵢₙ is generated in a way of sequentially listing the extracted main tokens, so that the length of the generated summarization token sequence may be within the initial context length Lₘₐₓ.

FIG. 7 exemplarily illustrates position information of input data and training data;

As illustrated in FIG. 7, it may be seen that the main tokens are evenly extracted from the entire position range of the input data Input through the summarization model. In this case, the extracted main tokens are tokens constituting the input data Input, and include position information corresponding to each position in the input data. Accordingly, position information that has not been previously trained may be trained, and the context length that may be allowed by the language model may be effectively increased.

According to the above description, it is possible to effectively train new token positions while maintaining existing computational costs by extracting a summarization token sequence of a length corresponding to the initial context length of the language model from the input data and performing additional training for the language model. In addition, main tokens including main information may be extracted using the extractive summarization model, so that data that interferes with training may be reduced, thereby improving efficiency of training.

The above-described context window expansion system 10 may be implemented in at least one computing device. For example, all functions of the context window expansion system 10 may be implemented in a single computing device, wherein the first function of the context window expansion system 10 may be implemented in the first computing device, and the second function thereof may be implemented in the second computing device. Alternatively, a specific function of the context window expansion system 10 may be implemented in a plurality of computing devices.

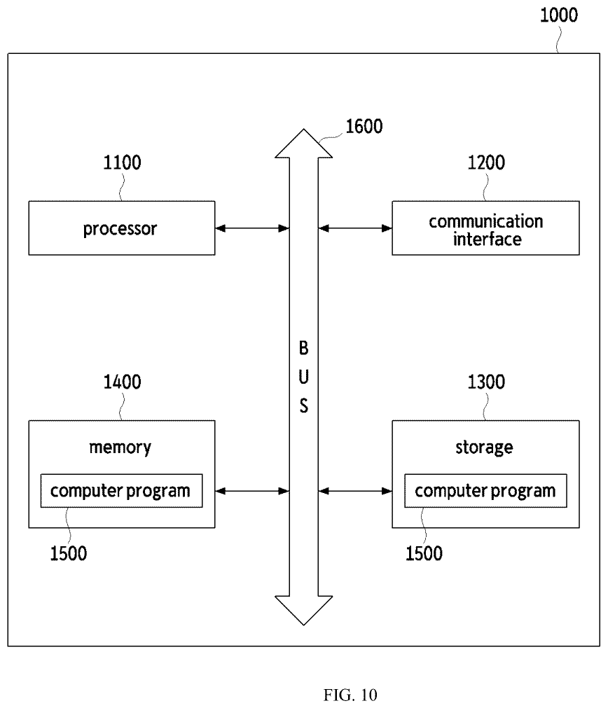

The computing device may include any device having a computing function, and an example of such a device will be understood with reference to FIG. 10. Since the computing device is an assembly in which various components (e.g., memory, processor, etc.) interact, it may be referred to as a ‘computing system’ in some cases. Also, the computing system may mean an assembly in which a plurality of computing devices interact.

The operation of the context window expansion system 10 according to some embodiments of the present disclosure has been schematically described with reference to FIGS. 1 to 7. The embodiments described above will be understood in more detail with reference to other embodiments to be described later. In addition, the technical spirits that may be understood through the above-described embodiments may be reflected in other embodiments to be described later, although not specified separately.

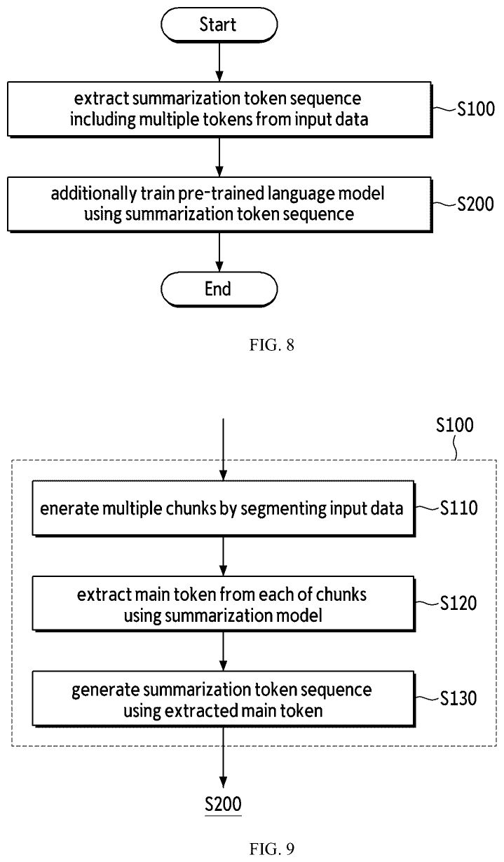

Hereinafter, a method for expanding a context window according to another embodiment of the present disclosure will be described in detail with reference to the drawings of FIG. 8. Hereinafter, in order to provide convenience of understanding, the description will continue on the assumption that all steps/operations of methods to be described later are performed by the above-described context window expansion system 10 (hereinafter, abbreviated as ‘system’). Therefore, when a subject of a specific step/operation is omitted, it may be understood that it is performed in the context window expansion system 10. However, in an actual environment, some steps of methods to be described later may be performed in other computing devices depending on the implementation method.

FIG. 8 is an exemplary flow chart illustrating a method for expanding a context window according to another embodiment of the present disclosure. However, this is only a preferred embodiment for achieving the object of the present disclosure, and it is obvious that some steps may be added or deleted as necessary.

As shown in FIG. 8, the method for expanding a context window according to the present embodiment may start in step S100 of extracting a summarization token sequence including a plurality of tokens from input data. The plurality of tokens include position information, and a length of the summarization token sequence may be within a reference length.

FIG. 9 is an exemplary flow chart illustrating a detailed process of the above-described extraction step S100. Hereinafter, the description will be given with reference to FIG. 9.

First, in step S110, a plurality of chunks may be generated by segmenting input data. The length of each of the plurality of chunks may be within the maximum token length of the summarization model.

Next, in step S120, a main token may be extracted from each of the plurality of chunks using the summarization model. In this case, the summarization model is a pre-trained extractive summarization model, and a main token(s) including main information may be extracted from each of the plurality of chunks, and the extracted main token(s) may be token(s) constituting the input data and include position information within the input data.

In one embodiment, an extraction ratio of the main token may be determined using the length of the input data and the initial context length of the pre-trained language model, and the main token may be extracted from each of the plurality of chunks in accordance with the determined extraction ratio.

Next, in step S130, the summarization token sequence may be generated using the extracted main token. In detail, the summarization token sequence may be generated by sequentially combining the main token(s) extracted from each of the plurality of chunks. As described above, since the summarization token sequence is generated by combination of the main tokens extracted in accordance with the extraction ratio determined using the length of the input data and the initial context length of the pre-trained language model, the length of the summarization token sequence may be within the initial context length of the pre-trained language model.

Referring back to FIG. 8, in step S200, the language model 20 pre-trained using the summarization token sequence is learned (trained).

The method for expanding a context window according to some embodiments of the present disclosure has been described with reference to FIGS. 8 and 9. As described above, the summarization token sequence for the input data including main information is generated using the extractive summarization model from the input data, and the token position information that has not been previously trained is trained using the summarization token sequence, whereby computing and time costs required to expand the context window of the language model may be greatly reduced, and as a result, usability of the language model may be greatly improved.

Hereinafter, an exemplary computing device 1000 capable of implementing the above-described system 10 will be described with reference to FIG. 10.

FIG. 10 is a block diagram illustrating a hardware configuration of a computing device according to some embodiments of the present disclosure.

Referring to FIG. 10, a computing system 1000 may include one or more processors 1100, a bus 1600, a communication interface 1200, a memory 1400 for loading a computer program 1500 performed by the processor 1100, and a storage 1300 for storing the computer program 1500. In FIG. 10, only components related to the embodiments of the present disclosure are shown. Accordingly, it may be apparent to those skilled in the art that other general components in addition to the components shown in FIG. 10 may be further included in the computing system 1000. That is, the computing system 1000 may further include various components in addition to the components shown in FIG. 10. In addition, in some cases, the computing system 1000 may be configured in a form in which some of the components shown in FIG. 10 are omitted. Hereinafter, each component of the computing system 1000 will be described.

The processor 1100 may control the overall operation of each component of the computing system 1000. The processor 1100 may be configured to include at least one of a Central Processing Unit (CPU), a Micro Processor Unit (MPU), a Micro Controller Unit (MCU), a Graphic Processing Unit (GPU), or any type of processor well known in the art of the present disclosure. In addition, the processor 1100 may perform computation for at least one application or program for executing the operations/methods according to the embodiments of the present disclosure. The computing system 1000 may include one or more processors.

The memory 1400 may store various types of data, commands and/or information. The memory 1400 may load the computer program 1500 from the storage 1300 to execute the operations/methods according to the embodiments of the present disclosure. The memory 1400 may be implemented as a nonvolatile memory such as a RAM, but the present disclosure is not limited thereto.

Next, the bus 1600 provides a communication function between components of the computing system 1000. The bus 1600 may be implemented as various types of buses such as an address bus, a data bus, and a control bus.

The communication interface 1200 may support wired/wireless Internet communication of the computing system 1000. The communication interface 1200 may support various communication modes other than Internet communication. To this end, the communication interface 1200 may be configured to include a communication module well known in the art of the present disclosure.

The storage 1300 may non-temporarily store one or more computer programs 1500. The storage 1300 may include a nonvolatile memory such as a read only memory (ROM), an Erasable Programmable ROM (EPROM), an Electrically Erasable Programmable ROM (EEPROM) and a flash memory, a hard disk, a detachable disk, or any type of computer-readable recording medium well known in the art to which the present disclosure pertains.

Next, the computer program 1500 may include one or more instructions for causing the processor 1100 to perform an operation/method according to various embodiments of the present disclosure when loaded into the memory 1400. That is, the processor 1100 may perform the operation/method according to various embodiments of the present disclosure by executing one or more loaded instructions.

For example, the computer program 1500 may include instructions for an operation of extracting the summarization token sequence including a plurality of tokens from input data, wherein the plurality of tokens include position information, and a length of the summarization token sequence is within a reference length, and an operation of additionally training a pre-trained language model using the summarization token sequence, wherein the reference length corresponds to the initial context length of the pre-trained language model.

As another example, the computer program 1500 may include instructions for performing at least some of the steps/operations/methods described with reference to FIGS. 1 to 9.

In some embodiments, the computing system 1000 shown in FIG. 10 may mean a virtual machine implemented based on cloud technology. For example, the computing system 1000 may be a virtual machine that operates on one or more physical servers included in a server farm. In this case, at least a portion of the processor 1100, the memory 1400 and the storage 1300, which are shown in FIG. 10, may be virtual hardware, and the communication interface 1200 may be implemented as a virtualized networking element such as a virtual switch.

An exemplary computing device 1000 capable of implementing the context window expansion system 10 according to some embodiments of the present disclosure has been described with reference to FIG. 10.

Various embodiments of the present disclosure and effects according to the embodiments have been mentioned with reference to FIGS. 1 to 10. The effects according to the technical spirits of the present disclosure are not limited to the above-mentioned effects, and other effects not mentioned will be clearly understood by those skilled in the art from the following description.

Furthermore, although a plurality of components have been described as being combined into one or operated in combination in the above embodiments, the technical spirits of the present disclosure are not necessarily limited thereto. That is, all of the components may operate to be selectively combined in one or more within the purpose scope of the technical spirits of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for expanding a context window, which is performed by at least one computing device, the method comprising:
extracting a summarization token sequence including a plurality of tokens from input data, the plurality of tokens including position information, and a length of the summarization token sequence being within a reference length; and
additionally training a pre-trained language model using the summarization token sequence,
wherein the reference length corresponds to an initial context length of the pre-trained language model.

2. The method of claim 1, wherein a length of the input data corresponds to a target context length of the pre-trained language model.

3. The method of claim 1, further comprising adding position information to a token constituting the input data prior to the extracting the summarization token sequence.

4. The method of claim 3, wherein the position information indicates an absolute position of the token constituting the input data.

5. The method of claim 1, wherein the extracting the summarization token sequence includes:
generating a plurality of chunks by segmenting the input data;
extracting a main token from each of the plurality of chunks using a summarization model; and
generating the summarization token sequence using the extracted main token.

6. The method of claim 5, wherein each length of the plurality of chunks is within a maximum token length of the summarization model.

7. The method of claim 5, wherein the extracting the main token includes determining an extraction ratio of the main token using a length of the input data and the initial context length of the pre-trained language model.

8. The method of claim 5, wherein the summarization model is an extractive summarization model, which is pre-trained.

9. A context window expansion system comprising:
one or more processors; and
a memory storing a computer program executed by the one or more processors,
wherein the computer program includes instructions for:
an operation of extracting a summarization token sequence including a plurality of tokens from input data, the plurality of tokens including position information, and a length of the summarization token sequence being within a reference length; and
an operation of additionally training a pre-trained language model using the summarization token sequence,
wherein the reference length corresponds to an initial context length of the pre-trained language model.

10. The context window expansion system of claim 9, wherein a length of the input data corresponds to a target context length of the pre-trained language model.

11. The context window expansion system of claim 9, further comprising instructions for an operation of adding position information to a token constituting the input data prior to the operation of extracting the summarization token sequence.

12. The context window expansion system of claim 11, wherein the position information indicates an absolute position of the token constituting the input data.

13. The context window expansion system of claim 9, wherein the operation of extracting the summarization token sequence includes:
an operation of generating a plurality of chunks by segmenting the input data;
an operation of extracting a main token from each of the plurality of chunks using a summarization model; and
an operation of generating the summarization token sequence using the extracted main token.

14. The context window expansion system of claim 13, wherein each length of the plurality of chunks is within a maximum token length of the summarization model.

15. The context window expansion system of claim 13, wherein the operation of extracting the main token includes an operation of determining an extraction ratio of the main token using a length of the input data and the initial context length of the pre-trained language model.

16. The context window expansion system of claim 13, wherein the summarization model is an extractive summarization model, which is pre-trained.

17. A non-transitory computer-readable storage medium storing computer program executable by a processor of a computer to execute:
extracting a summarization token sequence including a plurality of tokens from input data, the plurality of tokens including position information, and a length of the summarization token sequence being within a reference length; and
additionally training a pre-trained language model using the summarization token sequence,
wherein the reference length corresponds to an initial context length of the pre-trained language model.
